(19) United States
(12) Patent Application Publication
(10) Pub. No.: US 2004/0177143 A1
(43) Pub. Date: Sep. 9, 2004

(54) System and method for managing data processing devices

(76) Inventors: Frederico Buchholz Maciel, Kokubunji (JP); Shin Kameyama, Kodaira (JP); Toru Shonai, Hachioji (JP); Toshiaki Tarui, Sagamihara (JP); Mineyoshi Masuda, Kokubunji (JP)

Correspondence Address: ANTONELLI, TERRY, STOUT & KRAUS, LLP, 1300 NORTH SEVENTEENTH STREET, SUITE 1800, ARLINGTON, VA, 22209-9889, US

(21) Appl. No.: 10/627,826

(22) Filed: Jul. 28, 2003

(30) Foreign Application Priority Data
Feb. 26, 2003 (JP) 2003-049863

(51) Int. Cl. G06F 15/16

(52) U.S. Cl. 709/224; 709/208

(57) ABSTRACT

To provide a method for managing data processing devices, in which the misidentification of a management target can be prevented. The method for managing data processing devices is applied to a system in which a plurality of container mechanisms are provided each of which contains a plurality of data processing devices and a management unit is provided which monitors each data processing device to collect information concerning the state of the data processing devices and orders management operations to be performed on the data processing devices based on the collected information, this method for managing data processing devices including: specifying a container mechanism containing a data processing device on which a management operation needs to be performed; and displaying information about the management operation on a specified container mechanism side.

### BACKGROUND OF THE INVENTION

1. Field of the Invention

The present invention relates to a system and method for managing multiple computers, and more particularly to the reduction of errors occurring in management operations by remotely displaying management information including management targets and management procedures determined by a management software, the result of the said management operations as checked by the said management software, and the like.

2. Description of the Related Art

Medium- and large-size data centers include a large number of devices such as computer devices like servers, network devices like routers or switches, and storage devices like disk arrays. Due to the large number of these devices, and the complexity of the devices themselves, of their interconnections and of the programs that they run, in these data centers, management software is used in order to efficiently manage the system.

“JP1” is known as an example of management software, which manages jobs, networks, distribution, asset, storage, security, and the like in the system, thereby improving the efficiency of management operations (see Hitachi, Ltd., “Job Management Partner 1, Version 6i”).

In medium- and large-size data centers, an administrator manages the system from a management console (see the above-mentioned reference 1, page 21) on which the management software is running. When finding an event (such as a problem like a failure or the completion of a job execution) on a device, the management software displays the event along with an identifier of the device (number of its rack or cabinet, for instance) on the management console. The management software may also display a figure of the device on the management console (see Hitachi, Ltd., “Job Management Partner 1, Distribution Management/Resource Management”, page 9). When it is required to perform operations to solve a problem related to the event, the administrator performs these operations based on the displayed information.

FIG. 9 shows the system configuration of a data center. A device 3 (server, for instance) managed by a management software la running on a management apparatus 100 is contained in a rack 2 (generally, multiple devices 3 are contained in the rack, although only one device is illustrated to facilitate the understanding of the drawing). Also, a console 43 is in some cases connected to the device 3. This console 43 usually includes a keyboard, a mouse, and a display like a CRT, although if the device 3 is an appliance server or the like, a small liquid crystal display and several buttons may be used as the console 43. The management software 1a may collect information from the device 3 using various methods. The management software 1a first collects information about the device 3 from a monitoring process 32 running on the device 3. This monitoring process 32 consists of a program included with the device 3 for providing information using a standard management protocol, such as SNMP (see Internet Engineering Task Force, “A Simple Network Management Protocol (SNMP)”, RFC 1157), an agent program included with the management software 1a and installed on the device 3, or the like.

In some cases, the device 3 has a hardware mechanism 31 that monitors the device 3 (this mechanism will be hereinafter referred to as the “Baseboard Management Controller (BMC)”). The BMC 31 has a display that is different from the display of the console 43 (usually, a small liquid crystal display is used).

The management software 1a analyzes the information collected by the monitoring process 32 of the device 3 and displays the analysis result on a management console 19. Here, the management console 19 is generally located in a control room or the like, that is separated from a machine room where the device 3 is makes it impossible or extremely difficult for the administrator to see the information displayed on the management console 19 from the periphery of the rack 2.

FIG. 10 shows an example of the processing by the management software 1a. The management software 1a first performs an event reception (10) (where an event corresponds to a failure or the completion of batch processing or the like) from the BMC 31, the monitoring process 32, a diagnostic process 36, or the like. The management software 1a then performs an analysis on the event (11) by performing processing based on preset rules and/or pattern-matching. Following this, the management software 1a determines an action (such as reporting of the event or an operation to be performed by the administrator) that should be taken with reference to the analysis result and sends the determined action to dispatch processing 12. When the action is for the start of a management task 15 (execution of a program or the like), the management software 1a passes the action to task start 14. On the other hand, when the action is for the reporting to the administrator, the management software 1a displays the action on the management console 19 through console processing 13.

When the position or the figure of the device 3 needs to be displayed on the management console 19, the management software 1a consults a configuration information database 18 that stores information showing each rack 2 in the machine room and the position thereof, each device 3 in the rack 2 and the position thereof, each part of the device 3 and the position thereof, figures of the device 3 and the part, network connections among the devices, and the like. Note that when the administrator changes the system configuration (network wiring or the like) from the management console 19, the console processing 13 updates the information regarding the change in the configuration information database 18 accordingly.

This management console 19 is located in the control room, which is different from the machine room in which the device 3 is located. Usually, the machine room and the control room are away from each other, which leads to the necessity for the administrator to move from the control room to the machine room when coping with a problem displayed on the management console 19. In particular, the administrator necessarily needs to move to the machine room when he/she is required to perform an operation (such as the change/addition of network cable wiring, the on/off/reset of a server, or the replacement of a device or a part thereof) that cannot be performed from the management console 19. When the administrator moves to the machine room in order to conduct such an operation, however, there is a possibility that three problems described below may occur.

The first problem consists of the misidentification of an operation target.

In this case, the administrator performs the management operations in a wrong rack 2, a wrong device 3 in a rack, or a wrong part in a device (to simplify the description of this invention, every subject of manipulation in the devices is referred to as a “part” and even subjects that are not usually called a “part”, like a network port, are also dealt with as a part).

In this case, the management operations do not solve the problem with the device 3 that is the target of a management operation. Still worse, these management operations are performed on a wrong device 3 operating without any problems and thus may render this device 3 inoperable.

The second problem corresponds to the incorrect execution of operation steps. This problem arises when the administrator forgets any step (operational procedure) or incorrectly performs the contents of the management operation (such as the execution order of operation steps).

The third problem is the misjudgment of an operation result.

In the machine room, it is impossible to refer to the management console, so the administrator is incapable of judging whether a management operation has been completed normally since he/she doesn't receive feedback showing whether any errors occurred in the management operations, for instance. When one or more operations have been erroneously conducted, a problem arises but it takes a long period of time until the administrator recognizes the problem and takes countermeasures.

As a main result of the three problems described above, the availability of the system is lowered. In addition, security problems may occur in some cases.

In prior art, the first problem (misidentification of the operation target) and the second problem (incorrect execution of operation steps) are solved by adding a light emitting diode (LED) to the device 3 or a part thereof for three purposes described below. The first and most general purpose is to indicate the operating state using the LED. For instance, the LED is used to indicate the power-on state of a machine, the state of a network port (link up, or communicating), and the like. The administrator is capable of finding a failure by checking whether the LED is illuminated or blinking.

The second purpose is to indicate the occurrence of a failure in a device or part thereof using the LED (LED 37 in FIG. 9) (see RLX Corp., “RLX System 300ex Hardware Guide, Appendix A” in which the “fail LED” of the power supply, the “system failure LED” of the management switch, and the “board failure LED” of the server blade are described as examples thereof). In this case, when the diagnostic process 36 of the device 3 detects a failure, it illuminates or blinks the LED 37.

The third purpose is to designate the target of a management operation by illuminating or blinking the LED (LED 35 in FIG. 9) using the management software (see “InfiniBand specifications, 1.0a Volume 2”, pp 225 and 370 to 374). In this case, the management software 1a illuminates or blinks the LED 35 via a display agent 34.

The LEDs 37 and 35 are illuminated or blinked in the manner described above, so that the administrator becomes capable of finding a device or a part.

In other prior art, the first problem is solved by affixing a tag (barcode 33 in FIG. 9, or the like) to a device in order to identify this device.

In other prior art, the second problem (incorrect execution of operation steps) is solved by displaying an operation manual on a portable terminal (see IEEE Spectrum, October 2000, Volume 37, Number 10, ISSN 0018-9235).

In addition to these prior art, JP 08-289375A discloses a technique in which maintenance information necessary for the management operations is downloaded from a host computer to a personal computer and displayed.

Also, JP 10-222543A discloses a technique in which the position of a device that is the operation target and an inspection procedure are stored in a portable terminal.

Even in the prior art described above, however, the first problem (misidentification of the operation target) and the third problem (misjudgment of the operation result) described above are not sufficiently solved.

As to the first problem (misidentification of the operation target) described above, when the device is not operating (such as power-off state or in case of failure), the LEDs 35 and 37 do not function. Also, when multiple operations are reported in the data center at the same time, it is impossible to distinguish among these operations only with the LEDs. As a result, the danger that the administrator may perform an operation on a wrong device or part remains.

Also, the barcode 33 described above is not free from problems. In particular, in the case of a small part, there is no space for affixing a barcode in it, which makes it impossible to identify such parts only with the barcode 33.

Also, displaying a picture of the target device is insufficient. When multiple racks are provided in the same room and each rack has the same configuration, for instance, there is the danger that the administrator misidentifies the target rack and manipulates the wrong device.

As to the third problem (misjudgment of an operation result) described above, the LEDs are insufficient in some cases. For instance, even when the place (port) of a network connection is mistaken at the time of network wiring, the link up/communication LED may illuminate or blink, which makes it impossible to always identify a mistaken connection only with LEDs.

It is possible to summarize the problems to be solved by the present invention as follows. First, as to the first problem (misidentification of an operation target), with the prior art described above, the administrator does not obtain sufficient information to identify the target rack 2, device 3, or part. Also, as to the second problem (incorrect execution of operation steps), the administrator is not necessarily capable of conducting an operation while viewing a portable terminal at all times. In particular, when attaching/detaching a part in the rack 2, it is difficult for the administrator to perform this operation while viewing a portable terminal. As a result, there remains the danger of incorrect execution of operation steps.

Further, as to the third problem (misjudgment of an operation result), with the prior art described above, it is impossible to obtain feedback on an operation's result. Consequently, it is impossible to guarantee the correctness of the operation at all times.

### SUMMARY OF THE INVENTION

The present invention has been made in view of the problems described above, and it is therefore an object of the present invention to prevent the misidentification of the position of a management target. It is another object of the present invention to prevent the incorrect execution of operation procedures, and to improve management by obtaining feedback on an operation result.

According to the present invention, there is provided a method for managing data processing devices, which is applied to a system in which a plurality of containers are provided, each of which contains a plurality of data processing devices, and a management unit is provided which monitors each data processing device to collect information concerning the state of the data processing device and orders a management operation to be performed on these data processing devices based on the collected information, the method for managing data processing devices including: specifying a container containing the data processing device on which a management operation needs to be performed; and displaying information about the management operation on a specified container side.

In addition, the information about the management operation includes operational procedures, and the method for managing data processing devices further includes informing the result of the management operation to the management unit.

According to the present invention, when a management operation is to be performed on a data processing device, information about the management operation containing operation procedures is displayed on the specified container mechanism side. As a result, it becomes possible to prevent the misidentification (human error) of a target container mechanism (rack), data processing device, or part, and to prevent the reduction of availability resulting from this misidentification. In addition, the time taken by an administrator to perform an operation (such as repair) is shortened and software/hardware/network failures or the like are coped with without delay, so that it becomes possible to improve the system availability.

### BRIEF DESCRIPTION OF THE DRAWINGS

FIG. 1 is related to a first embodiment of the present invention and is a schematic diagram showing how a management apparatus and management software in a data center are related to each device.

FIG. 2 is a schematic diagram showing relationships among a BMC, the management apparatus, and the management software.

FIG. 3 is a schematic diagram of a case where a display is attached to the door of a rack.

FIG. 4 is a front view of the display and shows an example of information displayed on the display.

FIG. 5 is a schematic diagram showing functions of the management software.

FIG. 6 is related to a second embodiment and is a schematic diagram showing how the management apparatus and the management software are related to each device.

FIG. 7 relates to a third embodiment and shows an example of an operation manual.

FIG. 8 is related to a fifth modification and is a schematic diagram showing how the management apparatus and the management software are related to each device.

FIG. 9 is related to prior art and is a schematic diagram showing how the management apparatus and the management software are related to each device in the data center.

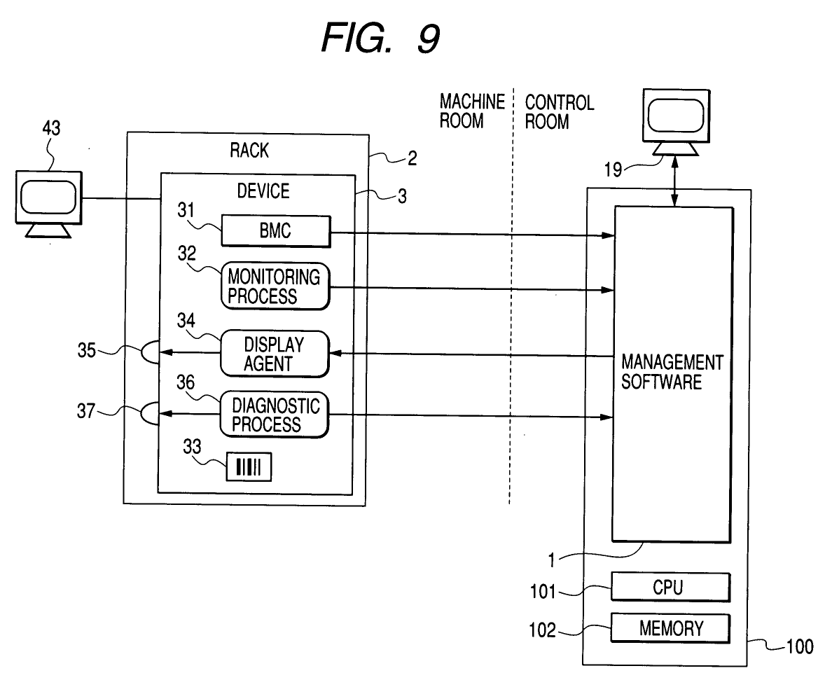

FIG. 10 is also related to prior art and is a schematic diagram showing functions of the management software.

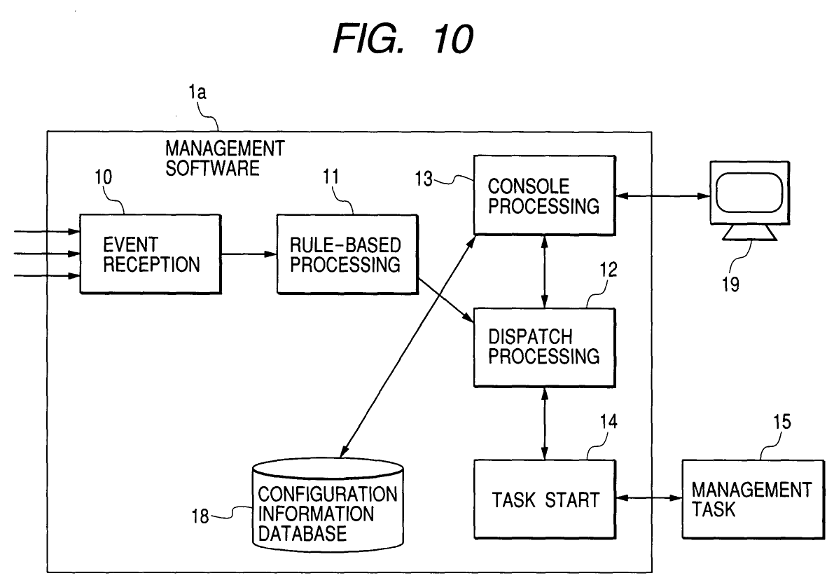

### DESCRIPTION OF THE PREFERRED EMBODIMENTS

<First Embodiment>

A first embodiment of the present invention will now be described with reference to the accompanying drawings.

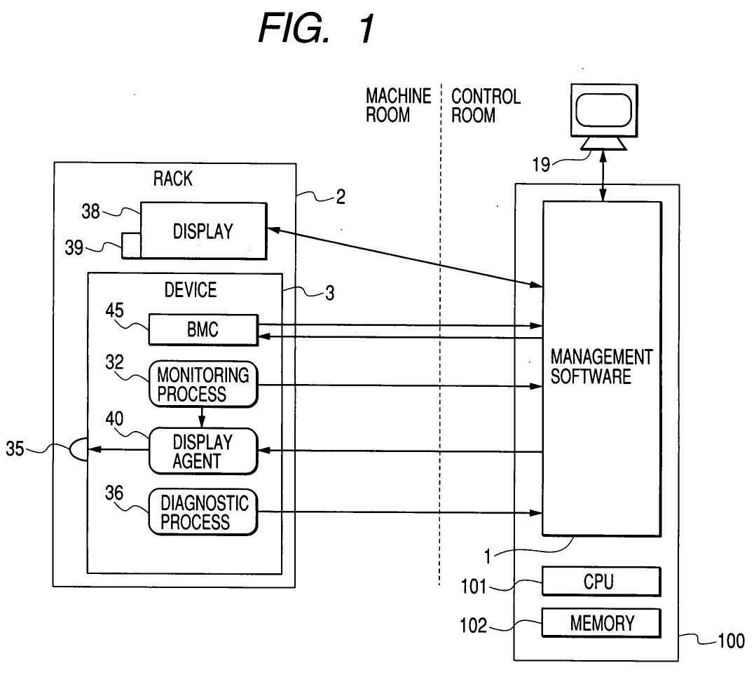

FIG. 1 relates to the first embodiment and shows a case where management information from management software 1 is sent to and displayed on a display provided in the vicinity of a device (data processing device) 3 to be managed based on the said management information.

FIG. 1 shows the system configuration in a data center.

In a machine room, multiple racks 2 are provided each of which contains multiple devices 3 such as a server. Note that only one device 3 is illustrated in this drawing.

In a control room separated from the machine room, a management apparatus 100 that manages the device 3 is provided.

The device 3 that is managed by the management software 1 running on the management apparatus 100 is contained in the rack 2 (generally, multiple devices are contained in the rack, although only one device is illustrated in order to facilitate understanding of the drawing). Also, the management apparatus 100 is equipped with one or more CPUs 101, a memory 102, one or more external storage devices (not shown), and one or more interfaces (not shown), and runs the management software 1. Also, when the device 3 is a server, this device 3 includes one or more CPUs (not shown), a memory (not shown), one or more external storage units (not shown), and the like, and carries out services as well as monitoring processes and diagnostic processes. Also, examples of the device 3 include network devices such as routers or switches, and storage devices such as disk arrays.

The management apparatus 100 includes a keyboard, a mouse, and a CRT display, and displays information collected and analyzed by the management software 1.

The device 3 is also equipped with an LED 35 that is connected to a display agent 40 of the device 3. When a monitoring process 32 carried out by the device 3 detects a failure or the like, the display agent 40 causes the LED 35 to illuminate or blink.

The management software 1 collects information from the device 3 by various methods. The management software 1 first collects information about the device 3 from the monitoring process 32 running on the device 3. This monitoring process 32 is realized by a program included with the device 3 and providing information using a standard management protocol such as SNMP, by an agent program included with the management software 1 and installed on the device 3, or the like.

The management software 1 also collects information about the device 3 from the diagnostic process 36 running on the device 3.

The device 3 in some cases includes a BMC 45 that is a hardware mechanism that monitors the device 3. This BMC 45 is provided with a display (not shown) that is different from a console 43 of the device 3 (usually, a small liquid crystal display is used).

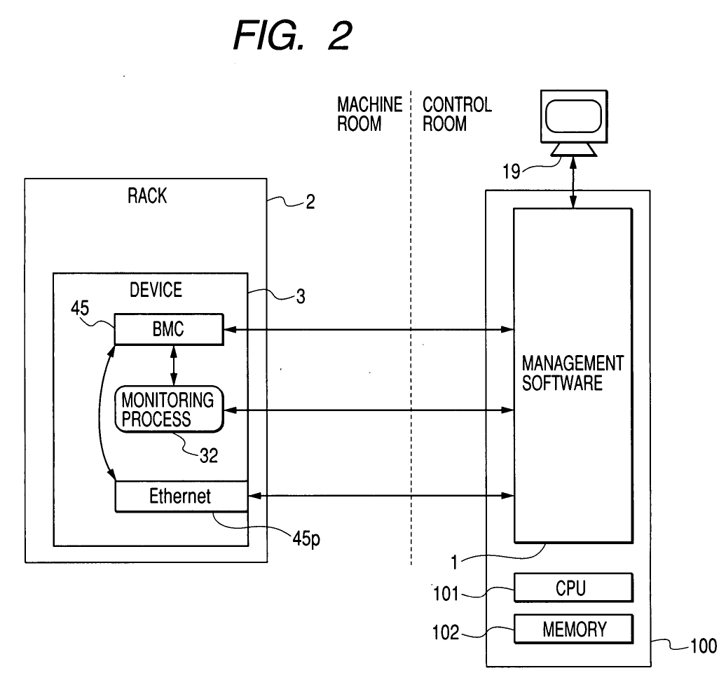

FIG. 2 shows an example of the BMC 45. In this drawing, the BMC 45 communicates with the management apparatus 100 and sends management information concerning the device 3 to the management software 1. The management software 1 analyzes the information about the device 3 collected from the BMC 45 and sends information concerning management operations to the BMC 45, which then displays the information of these management operations on the display of the BMC 45.

The BMC 45 uses a communication port 45p of the device 3 or is provided with its own communication port (not shown). This port is connected to a network (Ethernet (registered trademark), for instance) and the BMC 45 communicates with the management software 1 of the management apparatus 100 through this port.

The BMC 45 also performs the exchange of information with the monitoring process (program) 32 of the device 3, thereby obtaining the state and the like of the device 3 and informing the management software 1 of the obtained information.

Meanwhile, the rack 2 is provided with a display 38 onto which information sent from the management software 1 is displayed.

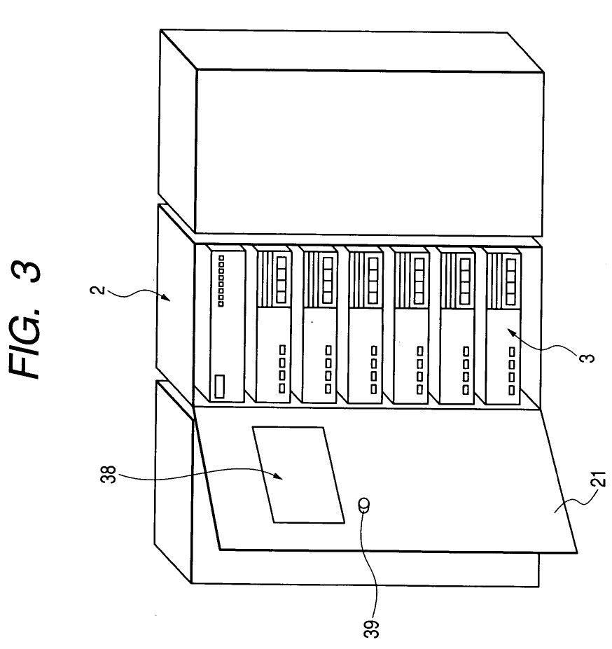

FIG. 3 shows an example of a location suitable for the display 38, which is provided inside of a door 21 of the rack 2. Given that administrators need to perform management operations from both the front and back of the rack 2 and, in particular, they need to move between the front and back thereof depending on the kind of the operation, that it is desirable that displays are provided for both of the front and back. That is, it is sufficient that the display 38 is provided at a position at which the administrator performing the management operation is capable of seeing the display 38 during the operations.

The management software 1 causes only displays the management information on the display(s) 38 of the rack 2 containing the device 3 or the parts that are the targets of the management operation. As a result, even if the administrator misidentifies the rack 2, he/she is capable of noticing this misidentification because the management information is not displayed on the display 38 of the wrong rack 2. Also, the management software 1 first displays the identifier of the administrator as management information. As a result, even if multiple administrators are performing multiple operations in the machine room and a certain administrator misidentifies his/her target rack 2 and views the display of the wrong rack 2 on which another administrator should perform an operation, the rack 2 displays an identifier (meaning that a management operation should be performed on this rack 2), but which is not his/her identifier. Therefore, the administrator is capable of noticing that he/she misidentified the target rack 2. Here, when the management software 1 displays a management operation on the management console 19, an administrator who is to undertake this management operation responds to the management software 1 that he/she will perform the operation, which allows the management software 1 to distinguish among the administrators who is in charge of which management operation. As a result, it becomes possible to clearly inform the administrator of the positions of the target device 3 and the part and to prevent the misidentification of the operation target with reliability. Note that, the subject of a manipulation in the device is referred to as a “part” and even a subject like a network port that is not usually called a “part” is also dealt with as a part.

In addition to the information described above, the management software 1 causes the display 38 to display identifiers of the target device 3 and the part for identification.

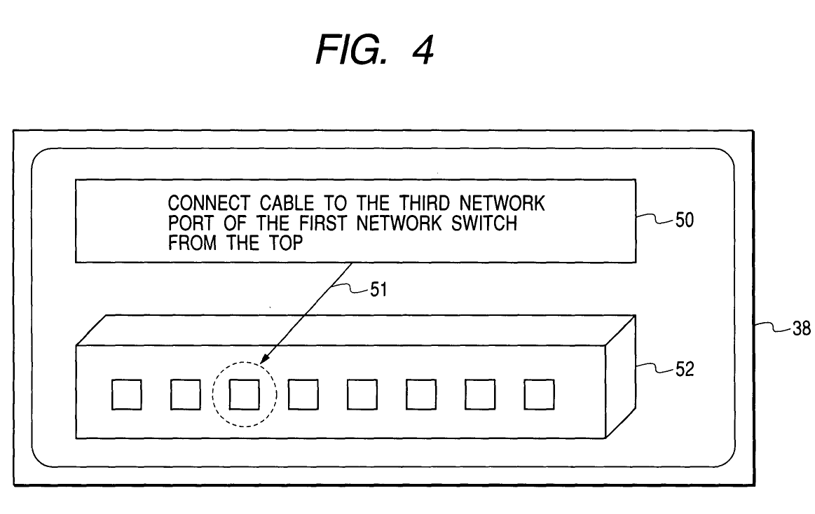

The management information can be displayed as text or images. FIG. 4 shows an example of the management information.

In FIG. 4, the display 38 displays a text 50 expressing an operation step. The display 38 also displays a figure (or an image) 52 of the device 3, thereby performing the specification of the target device (51) (first network switch from the top, in this example) and the target part (third network port, in this example). This clear specification prevents the administrator from misidentifying the target device 3 and the part.

The display 38 is provided with at least one button (or switch) 39 and the like, functioning as a means for sending a feedback to the management software 1. Each time the administrator completes an operation step, he/she pushes the button 39, thereby informing the management software 1 of the completion of the operation. Then, the management software 1 displays the next step. As a result, it becomes possible to prevent the incorrect execution of operation steps.

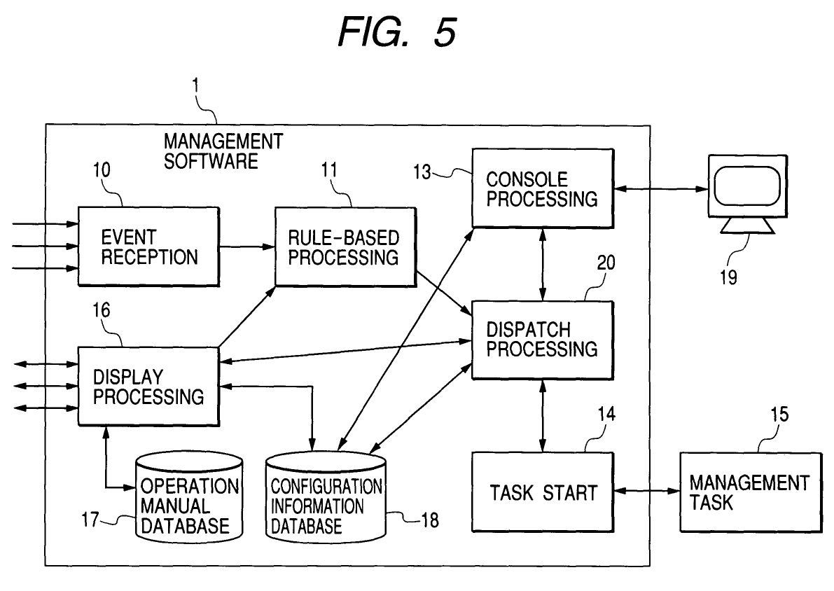

FIG. 5 shows an example of processing by the management software 1. The management software 1 first performs an event reception (10) (such as a failure or the completion of a batch processing) from the BMC 45, the monitoring process 32, the diagnostic process 36, or the like. The management software 1 then performs an analysis of the event (11) through processing based on preset rules and/or pattern-matching. Following this, the management software 1 determines an action that should be taken (such as reporting the event or an operation to be performed by the administrator) and sends this action to dispatch processing 20. When the action is for starting a management task 15 (such as the execution of a program), the action is passed to task start 14. On the other hand, when the action is for reporting to the administrator, the action is displayed on the console 19 through console processing 13.

When the position or figure of the device 3 that is the management target is to be displayed on the management console 19, the management software 1 consults a configuration information database 18 that stores information showing each rack 2 in the machine room and the position thereof, each device 3 in the rack 2 and the position thereof, each part of the device 3 and the position thereof, figures of the device 3 and the part, network connections among the devices, and the like.

Then, when an action that should be performed by the administrator occurs, and an administrator responds to the management console 19 that he/she will undertake this management operation, the console processing 13 informs the dispatch processing 20 of the identifier of the administrator (i.e., inputs his/her identifier into the dispatch processing 20). Then, the dispatch processing 20 transfers the identifier of the management operation, the identifier of the management target, and the identifier of the administrator to display processing 16.

The display processing 16 first consults the configuration information database 18 with reference to the identifier of the management target, thereby finding the target rack 2 and at least one display 38 related to the rack 2. After that the display processing 16 exchanges management information about the management operation with the display 38. Next, as described above, the display processing 16 causes the display 38 to first display the identifier of the administrator and the identifier of the management target. Following this, the display processing 16 consults an operation manual database 17 (hereinafter referred to as the “operation manual DB” 17), which stores information showing each step of each management operation, with reference to the identifier of the management operation, thereby obtaining operation steps. Finally, the display processing 16 transmits the steps to the display 38.

It should be noted here that when the administrator changes the system configuration from the management console 19, the console processing 13 updates the information concerning the change in the configuration information database 18 accordingly and issues an event related to this change of the system configuration, thereby instructing the administrator to conduct the configuration change. This event is transferred to the display processing 16 via the dispatch processing 20, and the display processing 16 performs the processing described above.

As described above, when the necessity of management of the device 3 is detected based on the information collected by the management software 1 of the management apparatus 100, the target rack 2, the position of the target device 3, the management operation that should be performed (such as the change/addition of network cable wiring, the on/off/reset of a server, the replacement of a device or a part thereof), and the like are first displayed on the management console 19 of the management apparatus 100 as a management request.

Next, in response to the management request from the management console 19, an administrator who is to undertake the management operation inputs his/her identifier, thereby responding to the management software 1.

The management software 1 transmits the identifier of the administrator, the identifier of the management target, and the first step (procedure) of the management operation to the display 38 corresponding to the management target. Then, the display 38 displays this information.

Following this, the administrator moves from the control room to the machine room, gets near the designated rack 2, opens its door 21, and looks at the display 38.

If the display 38 displays no information, this means that the administrator misidentified the target rack 2. Also, even when the display 38 displays any information, if the identifier of the administrator is not displayed, this means that the administrator misidentified the target rack 2. As a result, even if multiple management requests are issued, the administrator is prevented from misidentifying the target rack 2.

Next, the administrator confirms the operation step displayed on the display 38 in the manner shown in FIG. 4, and then actually starts the management operation. Following this, when the management operation or the operation step is completed, the administrator pushes the button 39 provided in the vicinity of the display 38, thereby informing the management software 1 that he/she performed the designated management operation.

As a result, it becomes possible to execute the operation step with precision and to prevent the incorrect execution of the operation step with reliability. Also, it becomes possible to feed back the completion of the management operation to the management software 1 by pushing the button 39 at the time of completion of the management operation or the operation step, which makes it possible to guarantee the correctness of an operation result. The operation completion is reported by the administrator in front of the device 3 that is the management target, so that it becomes possible to perform precise reporting of the result while eliminating ambiguities.

A case where the management information is displayed on the display 38 has been described above. However, the present invention is not limited to the above form and the information management may be displayed on the display of the BMC 45 in place of the display 38, for instance.

It should be noted here that the hardware of the BMC 45 and the display 38 are independent of the device 3 and include an independent power source, storage units (memory), and processing unit (CPU). As a result, even if the device 3, such as a server, falls into an inoperable state, it is possible to monitor the state of the power source and the like of the device 3 and to inform the management software 1 of the state.

In prior art, when an administrator performs multiple management operations, if he/she inputs the result of an operation performed on a rack and the result of an operation performed on another rack into the management console 19 after returning to the control room, he/she forgets the detailed contents of the operations, which leads to the danger that the reporting of the result of each operation step may become ambiguous.

In contrast to this, according to the present invention, it is possible to report the completion of an operation at the position of the management target. As a result, it becomes possible to guarantee the correctness of an operation result with ease.

<Second Embodiment>

In this embodiment, a method will be described in which the management information is transmitted from the management software 1 to the device 3, which is the management target, and is displayed by the device 3.

The management software 1 in this embodiment performs the same processing as in the first embodiment. However, in this embodiment, when consulting the configuration information database 18 with reference to the identifier of the management target, the management software 1 looks for the target device 3 instead of the target rack 2 and the display 38, and thereafter exchanges management information about management operations with the target device 3.

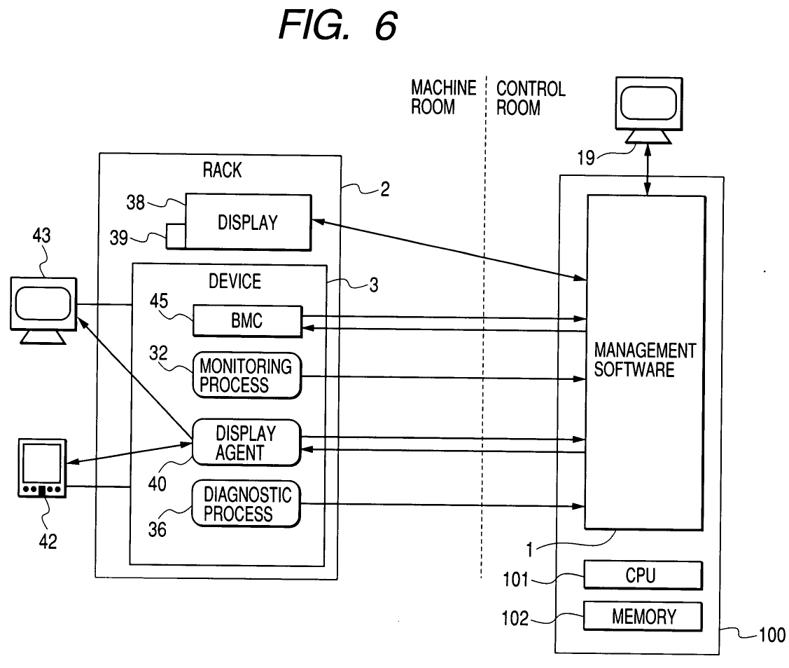

When the management information is transmitted to the device 3, as shown in FIG. 6, it is possible to display the management information on a display different from the display 38. For instance, it is possible to display the management information on the console 43 connected to the device 3. In this case, the target device 3 is identified through this console 43.

In this case, the management software 1 transmits the management information to the device 3, which then displays the management information on the console 43 via the display agent 40. Even in this case, it is possible to prevent the misidentification of the operation target and the incorrect execution of operation steps with reliability, to feed back a report of an operation result to the management software 1 with precision, and to guarantee the correctness of the operation result, like in the first embodiment.

It is also possible to display the management information on a portable terminal (such as a PDA) 42 instead of the display 38. In this case, the portable terminal 42 is connected to the device 3 using a serial or USB cable, and receives the management information via the device 3. In this case, the device 3 is identified based on the physical connection using the serial or USB cable. Instead of the physical connection, it is conceivable the use of infrared communication devices that are widely used by laptop computers, palmtop computers like electronic organizers, and the like. In the case of the infrared communication, the infrared communication ports of the portable terminal 42 and the device 3 need to be facing each other, which makes it possible to clearly identify the device 3. Note that the present invention is not limited to serial, USB, and infrared communication, and different physical communication methods or wireless connection methods may be used.

In FIG. 6, the communication with the console 43 and the portable terminal 42 is realized via the display agent 40 (in FIG. 6, the infrared communication is not illustrated, although this communication is performed in the same manner as in the case of the console 43 and the portable terminal 42). However, the present invention is not limited to this configuration and the communication may be realized via another mechanism.

In the case of the serial, USB, and infrared communication, the management software 1 performs the same processing as in the first embodiment. In this embodiment, however, when consulting the configuration information database 18 with reference to the identifier of the management target, the management software 1 looks for the target device 3 instead of the target rack 2 and the display 38, and thereafter exchanges the management information about management operations with the said device 3.

Also, the communication between the portable terminal 42 and the device 3 may be performed using a wireless communication standard such as Bluetooth (registered trademark). Here, the Bluetooth stipulates Class 1, Class 2, and Class 3 having different output powers. The maximum output powers in Class 1, Class 2, and Class 3 are +20 dBm (100 mW), +4 dBm (2.5 mW), and 0 dBm (1 mW), respectively. Also, the maximum communication distances in Class 1, Class 2, and Class 3 are around 100 m, around 10 m, and around several meters, respectively. As a result, it is preferable that Class 3 is adopted.

By performing communication between the portable terminal 42 and the device 3 using Bluetooth using low output power, it becomes possible for the administrator to sequentially connect the portable terminal 42 to many devices 3 contained in many racks 2 while moving around the machine room. When the administrator gets near the management target device 3, he/she becomes capable of viewing the management information about the target for the first time. As a result, the administrator can roughly identify the position of the management target. The administrator then opens the rack 2 corresponding to the identifier displayed on the portable terminal 42, which makes it possible to perform the management operation on the target device 3. The communication between the portable terminal 42 and the device 3 is performed using a communication unit that performs short-distance communication with a low output power, so that it becomes possible for the administrator to know the position of the target device 3 without opening the door 21 of the rack 2.

It should be noted here that it is possible to combine the methods or devices of this embodiment with the methods or devices of the first embodiment for concurrent use. When the display processing 16 of the management software 1 receives a management operation, the management software 1 may consult the configuration information database 18, check in the manner described above whether or not the display 38, the BMC 45, or the like related to the management operation exists, select one of the existing display units, and display management information using the selected display unit.

<Third Embodiment>

In this embodiment, a method will be described in which an operation result checked by the management software 1 is fed back to an administrator.

In order to check the result of management processing, the display processing of the management software 1 adds a rule, in accordance with which the result is to be checked, to the rule-based processing 11 shown in FIG. 5. First, in order to check whether the management processing has been completed normally, a rule for checking whether the management operation (and operation steps) that is currently displayed has ended with success (for instance, whether a replaced part operates normally) is added to the ruled-based processing 11. An action stipulated by this rule is set as the completion of the management operation (and the operation steps). Like other actions, this action is transmitted to the display processing via the dispatch processing 20.

Two methods are usable in order to check whether a problem (such as an error) occurs in the operation. In the first method, when the added rule that checks for normal completion is not satisfied even when the administrator completes the operation steps and pushes the button 39 shown in FIG. 1, a report is issued showing that a problem occurred in the management operation.

In the second method, a rule is added to check whether a problem occurred in the management operation. This rule detects, for instance, whether an event occurred in different device 3 in the same rack 2, whether an event occurred in a different part of the same device 3, and the like. Note that it is possible to concurrently use these two methods (when the latter rules do not cover every operational problem, the operation error detection is performed using the former rule). When the management operation is completed, the display processing 16 deletes the rules added to the operation.

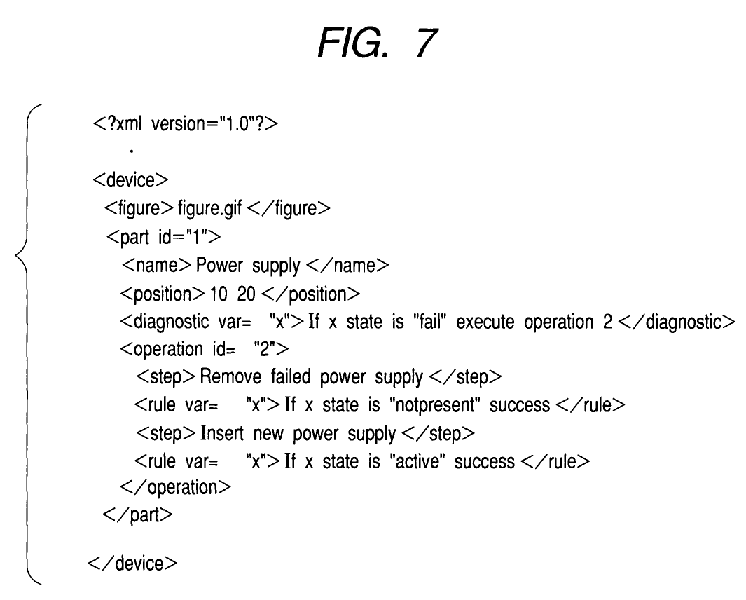

FIG. 7 shows an example of the contents of the operation manual DB 17 written in XML (see Elliotte Rusty Harold, “XML Bible”, IDG Books, 1999, ISBN 0-7645-3236-7).

In FIG. 7, a description defining the target device 3 (between <device> and </device>) includes a description defining a figure of the device (between <figure> and </figure>) and a description defining the target part (between <part id=“1”> and </part>) (in FIG. 7, only one part, a power source, is defined, although multiple parts may be defined). The description defining the part includes a description defining the name of the part (between <name> and </name>), a description defining the coordinates of the part in the figure (between <position> and </position>), a description defining the diagnostic rule (between <diagnostic var=“x”> and </diagnostic>), and a description defining the management operation to be performed on the part (between <operation id=“2”> and </operation>). The description defining the management operation (replacement of a power supply, in this example) includes descriptions defining two steps (between <step> and </step>) and descriptions defining two rules (between <rule var=“x”> and </rule>). These rules check the results of the operation steps for normal completion and/or for the occurrence of errors (only rules for detecting normal completion are shown in this example).

Each target part and management operation are given an identifier (id=“1” and id=“2”, in this example) and each rule is given a variable (var=“x”). When a failure of the power supply (x) is found with reference to the diagnostic rule, the management operation assigned the identifier “2”is started. Then, whether the first operation step has been completed normally is checked using the rule for checking the result of this operation step.

In this manner, after the first operation step is performed and the failed power supply is detached, the presence or absence of the power supply is confirmed using the rule. When the operation has been performed correctly, it becomes possible to proceed to the next operation step. In this manner, the incorrect execution of the operation steps is prevented and the correctness of the operation result is guaranteed.

It should be noted here that the format used to define the rules differs depending on the management software 1, although it is sufficient that the rules are defined in the manner shown in FIG. 7.

Also, the result of each operation step may be automatically reported by the management software 1 via the BMC 45, the monitoring process 32, and the diagnostic process 36, instead of reporting it through the pushing of the button 39.

For instance, in the case of the operation steps in FIG. 7, when the BMC 45 detects the detachment of the failed power supply, the completion of the first operation step is decided. Next, when the BMC 45 detects the attachment of a new power supply, the completion of the next operation step is decided. In this case, the administrator performing the management operation becomes capable of guaranteeing the correctness of the operation results while omitting responses to the management software 1.

Further, the management software 1 may judge whether or not the report from the BMC 45 is correct and, if an error is found in an operation step, inform the display 38 or the management console 19 of the error for displaying. As a result, it becomes possible to warn of the error occurring in the management operation in real time and to instruct the administrator to execute the operation step again.

<Modifications>

The present invention is not limited to the embodiments and modifications thereof described above. That is, the present invention is also attainable according to modifications described below and through combination of the techniques described in the embodiments and the modifications thereof with the following modifications.

<First Modification>

Instead of the display 38 described in the first embodiment, another display method may be used. For instance, the rack may be provided with an LED like the LED 35 that is to be illuminated/blinked by the management software 1. In this case, when only one management operation exists in the data center, it becomes possible to prevent the misidentification of the target rack 2.

<Second Modification>

The place to which the display 38 of the first embodiment is attached is not limited to the rack 2. When the device 3 is a blade server, for instance, the display may be provided in the chassis of the blade server. In this case, one of blades may be set as the display (in this case, the display is constructed so as to be able to slide over the board of the blade, thereby allowing the administrator in management operation to view the information on the display by sliding the display to the outside).

<Third Modification>

When multiple management operations take place at the same time, in order to prevent the misidentification of management targets and the confusion over the operations, the management operations may be scheduled. In this case, only one management operation in an operation range (the rack 2, for instance) is outputted from the management console 19 to the display 38 or the device 3. In this case, when receiving an action for performing a management operation from the rule-based processing 11, the dispatch processing 20 consults the configuration information database 18 and checks whether or not another management operation is currently being performed in the same operation range. When different management operations should be performed on the same rack 2, new management operations are held until the current management operation is completed. By limiting the number of management operations that can be performed on the same rack 2 at a time to one in this manner, the misidentification of the target device 3 and the part is prevented.

<Fourth Modification>

The present invention is applicable without excluding prior art, and may be concurrently used with it. For instance, concurrently with the displaying on the display 38, the LED 35 or the LED 37 may be used. Also, the concurrent use of the aforementioned various methods of the present invention is possible.

<Fifth Modification>

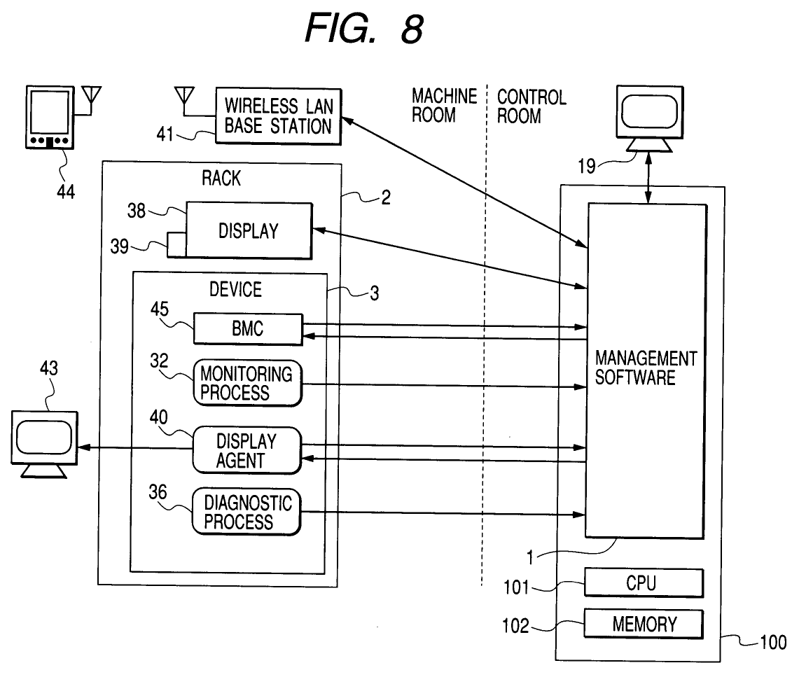

As shown in FIG. 8, instead of the display 38, a portable terminal 44 may be used and management information may be exchanged through a wireless local area network (LAN). In this case, the communication with the portable terminal 44 is performed via a wireless LAN base station (relay unit) 41. The portable terminal 44 communicates only with the wireless LAN base station 41 whose communication range covers the position of the target rack 2 (that is, a wireless LAN base station 41 that is capable of communicating with the target rack 2). Here, when multiple wireless LAN stations 41 are capable of communicating with the target rack 2, one of them (nearest wireless LAN station 41, for instance) is selected. As a result, the portable terminal 44 becomes capable of exchanging management information only when it is located on the periphery of the target rack 2, which makes it possible to roughly identify the position of rack 2. In this modification, however, in contrast to the first embodiment in which the rack 2 is identified by sending the management information only to the display 38 of the target rack 2, it is impossible to perfectly identify the target rack 2. In view of this problem, the target rack 2, device 3, and the part are identified through the combination with another method of the present invention or prior art, as described in the fourth modification.

<Sixth Modification>

The present invention is also applicable to a case where an independent computer, such as a personal computer, is used as the console of the device 3. In this case, the management information is sent to this independent computer.

<Seventh Modification>

The present invention is also applicable to the management software bundled with the device 3 or a system (such as the management apparatus 100) as well as to management software 1 that is sold independently of the device 3. Software for controlling a parallel computer is an example of management software bundled with a device.

<Eighth Modification>

In the present invention, there is the need for information showing the type (model name or the like) of each device 3, each part thereof, their position thereof, a management operation (management steps and a rule for detecting normal completion or an operation error, for instance), and the like. If the administrator creates this information, too much time is consumed and thus the management cost in the data center increases. In view of this problem, this information may be defined in a standardized format. In this case, when the manufacturer of each device 3 provides the information using this format, the management software 1 becomes capable of using the provided information as the configuration information database 18 and the operation manual DB 17. An example of the standardized format is the format shown in FIG. 7.

It should be noted here that a program for carrying out the present invention may be sold in the form of a program stored in a program storage medium, such as a disk storage device, by itself or along with another program. Also, the program for carrying out the present invention may be a program to be added to an already installed communication program or a program that replaces a part of the existing communication program.

Also, the management operation information may contain multiple operation steps (operation procedures) and a procedure for, after the operation steps are displayed, monitoring the state of a target data processing device and transmitting results of the operation steps to the management apparatus.

Also, an equipment may be connected to the data processing device via an infrared communication unit and exchange management information with the target data processing device.

Also, the equipment may be connected to the data processing device via a wireless communication unit and exchange management information with the target data processing device.

Also, the equipment may be connected to the data processing device via a wireless communication unit and exchange management information with the target data processing device, with the wireless communication unit being a wireless communication unit (Bluetooth unit) having a short range and a low output power.

Also, the management operation information may be a text or a figure specifying the position of the target data processing device in the rack and the operation target.

Also, the number of management operations or the number of administrators performing the management operations may be limited to one for each rack or each communication range of a wireless network.

Also, the management operation information may describe a part that is the target of a management operation.

Also, a management unit may sequentially inform the rack side of operation procedures preset as the management operation information, and a report may be issued from the rack side to the management unit each time an operation procedure completes.

Also, the management unit may sequentially inform the rack side of operation procedures preset as the management operation information, and a report may be issued from the rack side to the management unit each time a monitoring agent of the target data processing device detects the completion of an operation procedure.

What is claimed is:

1. A method for managing data processing devices, which is applied to a system in which a plurality of container mechanisms are provided, each of which contains a plurality of data processing devices, and a management unit is provided which monitors each data processing device to collect information concerning a state of the data processing device, and orders a management operation to be performed on the data processing device based on the collected information,
the method for managing data processing devices comprising:
specifying a container mechanism containing a data processing device on which a management operation needs to be performed; and
displaying information about the management operation on a specified container mechanism side.

2. A method for managing data processing devices according to claim 1, further comprising informing a result of the management operation to the management unit.

3. A method for managing data processing devices according to claim 2, further comprising judging whether an error exists in the informed result of the management operation and, if an error is found, informing the container mechanism side of the occurrence of the error.

4. A method for managing data processing devices according to claim 1, wherein the management operation information is displayed on a display provided for the container mechanism.

5. A method for managing data processing devices according to claim 1, wherein one of the data processing devices and the container mechanism includes a wireless communication unit, and wherein the position of the specified container mechanism is identified, the management operation information is transmitted to the wireless communication unit via a relay unit whose communication range contains the identified position of the container mechanism, and the transmitted management operation information is displayed on the container mechanism side.

6. A method for managing data processing devices according to claim 1, wherein the data processing device is connected to an equipment, which includes a display portion for displaying the management operation information, in a wired or wireless manner, and wherein the management operation information sent to the container mechanism side is transmitted to the equipment and is displayed on the display portion.

7. A method for managing data processing devices according to claim 6, wherein the equipment is a monitoring agent that is connected to the data processing device and monitors the state of the data processing device, and wherein the management operation information is received by the monitoring agent and is displayed on a display of the monitoring agent.

8. A method for managing data processing devices according to claim 6, wherein the equipment is a display connected to the data processing device, and wherein the management operation information is received by the data processing device and is displayed on the display.

9. A method for managing data processing devices according to claim 6, wherein the equipment is a portable terminal including a display portion, and wherein the management operation information is received by the data processing device, the data processing device transmits the management operation information to the portable terminal when the portable terminal and the data processing device are connected to each other, and the management operation information is displayed on the display portion.

10. A method for managing data processing devices according to claim 1, wherein the management operation information contains an operation target and an operation procedure, wherein the specification of the container mechanism is performed by a management apparatus, and wherein the displaying of the management operation information is performed by a data processing device at a distance from the management apparatus.

11. A data processing device management system, comprising:
a plurality of container mechanisms that each contain a plurality of data processing devices;
a monitoring unit that monitors a state of each data processing device in each container mechanism; and
a management unit that collects information concerning the state of the data processing device from the monitoring unit via a communication unit, and creates management operation information based on the collected information,
wherein each container mechanism is provided with a display unit that displays information from the management unit, and
wherein the management unit includes a remote display unit that transmits the management operation information to the display unit of a container mechanism containing a data processing device on which a management operation needs to be performed.
